(19) United States
(12) Patent Application Publication
(10) Pub. No.: US 2012/0321379 A1
(43) Pub. Date: Dec. 20, 2012

(54) LOCKING STRUCTURE

(75) Inventors: YUAN-MING WANG, Shenzhen City (CN); XUE-FENG WAN, Shenzhen City (CN); ZHAO-YONG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/187,546

(22) Filed: Jul. 21, 2011

(30) Foreign Application Priority Data
Jun. 14, 2011 (CN) 201110158987.6

(51) Int. Cl. F16B 21/06

(52) U.S. Cl. 403/321

(57) ABSTRACT

A locking structure includes two first locking members disposed on a first object and two second locking members disposed on a second object for engaging with the first locking members respectively. Each first locking member includes a main body protruding from the first object and a first engaging portion protruding from the main body. The first engaging portions of the two first locking members face away from each other. Each second locking member includes a main part protruding from the second object and a second engaging portion protruding from the main part. The second engaging portions of the two second locking members face each other. The second engaging portions engage with and abut the first engaging portions respectively to lock the second object to the first object.

### BACKGROUND

1. Technical Field

The present disclosure relates to a locking structure for locking two objects together.

2. Description of Related Art

In assembly of many electronic devices, screws or locking structures are often used for locking two components of the electronic device together. However, a tool such as a screwdriver is often required when using screws, which is inconvenient. Many locking structures include a slot defined in a first object and a hook disposed on a second object, and the hook must be deformed using considerable strength or power to get the hook into the slot to lock the two objects together. This may result in damage to locking structure and/or the objects.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a locking structure according to an embodiment of the present disclosure. The locking structure includes two first locking members and two second locking members engaged with the first locking members respectively.

FIG. 2 is a schematic view showing the second object in the process of being locked to the first object.

FIG. 3 is a schematic view showing the engagement between the first locking members and the second locking members of FIG. 1.

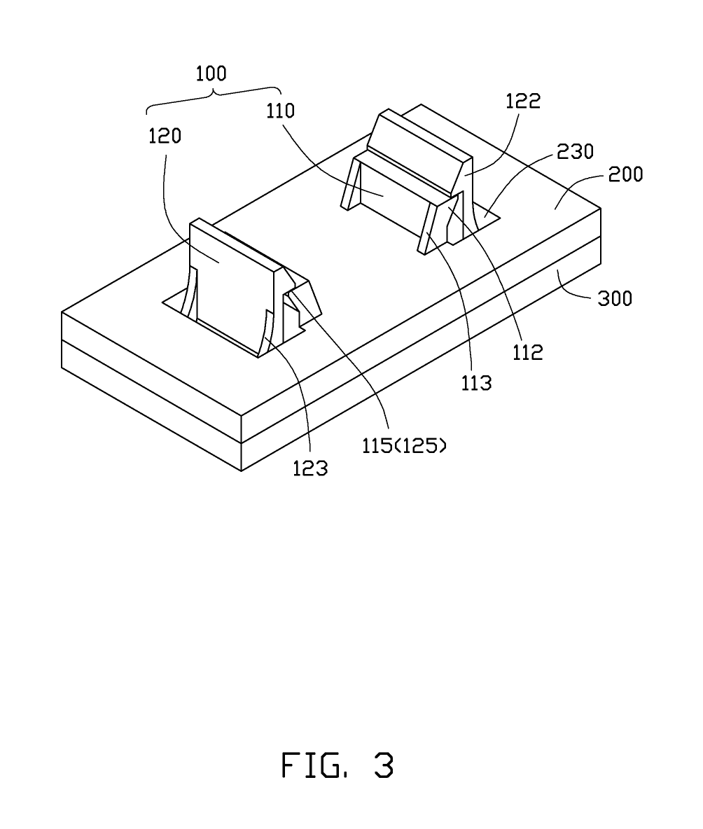

### DETAILED DESCRIPTION

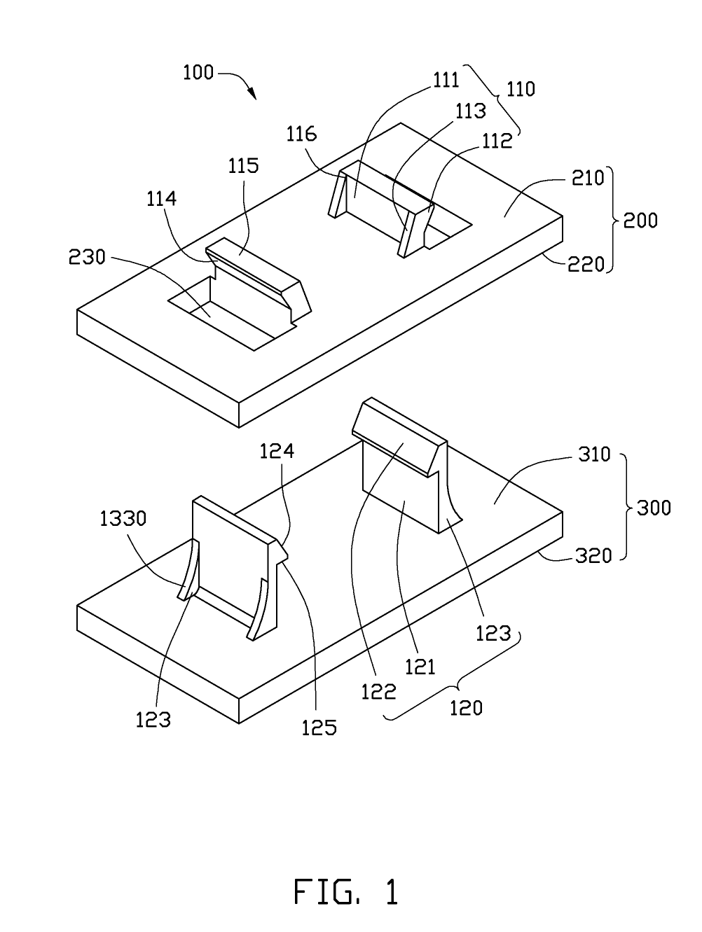

Referring to FIG. 1, a locking structure 100 is used for locking a first object 200 and a second object 300 together. In some embodiments, the first object 200 may be an electronic device such as an optical disk player or a notebook computer, or a component of the electronic device, and the second object 300 may be another component of the electronic device or another electronic device. In the illustrated embodiment, the locking structure 100 includes two first locking members 110 disposed on the first object 200, and two second locking members 120 disposed on the second object 300. The second locking members 120 engage with the first locking members 110 respectively to lock the second object 200 to the first object 300. In some embodiments, the first locking members 110 and/or the second locking members 120 may be elastic.

The first object 200 includes a first surface 210 and a second surface 220 opposite to the first surface 210. Two through holes 230 are defined in the first object 200 to communicate the first surface 210 with the second surface 220. The through holes 230 may be differently shaped in different embodiments. In the illustrated embodiment, the through holes 230 are rectangular holes.

The first locking members 110 protrude from the first surface 210 and are located between the two through holes 230. The two first locking members 110 are adjacent to the two through holes 230 respectively. Each first locking member 110 includes a main body 111, a first engaging portion 112, and two reinforced ribs 113. The main body 111 protrudes perpendicularly upwards from the first surface 210. The engaging portion 112 protrudes laterally from one side of the main body 111 facing the corresponding through hole 230 and adjacent to the free end of the main body 111. That is, the first engaging portions 112 of the two first locking members 110 face away from each other. Each engaging portion 112 is wedge shaped and defines a first guiding surface 114 and a first abutting surface 115 connected to the first guiding surface 114. In the illustrated embodiment, the first guiding surface 114 is an inclined surface and the first abutting surface 115 is parallel to the first surface 210. The ribs 113 extend from one side of the main body 111 which is away from the corresponding through hole 230 and are connected to the first surface 210. In the illustrated embodiment, each rib 113 is substantially triangular.

The second object 300 has a third surface 310 corresponding to the second surface 220 and a fourth surface 320 opposite to the third surface 310. The two second locking members 120 protrude from the third surface 310 for engaging with the first locking members 110 respectively.

Each second locking member 120 includes a main part 121, a second engaging portion 122, and two support ribs 123. The main part 121 protrudes perpendicularly upwards from the third surface 310. The second engaging portion 122 protrudes laterally from one side of the main part 121 which faces the main part 121 of the other second locking member 120 and is adjacent to the free end of the main part 121. That is, the two first engaging portions 122 of the two second locking members 120 face each other. The second engaging portion 122 is also wedge shaped and defines a second guiding surface 124 and a second abutting surface 125. The second guiding surface 124 is slidable relative to the first guiding surface 114 while the second abutting surface 125 can abut the first abutting surface 115. In the illustrated embodiment, the distance between the second abutting surface 125 and the third surface 310 is substantially equal to the distance between the first abutting surface 115 and the second surface 220. The two support ribs 123 protrude from two opposite ends of the other side of the main part 121 to be connected to the third surface 310. In the illustrated embodiment, each support rib 123 is substantially triangular and includes one flange 1230 connected to the main part 121 and the third surface 310. The flange 1230 is arc-shaped.

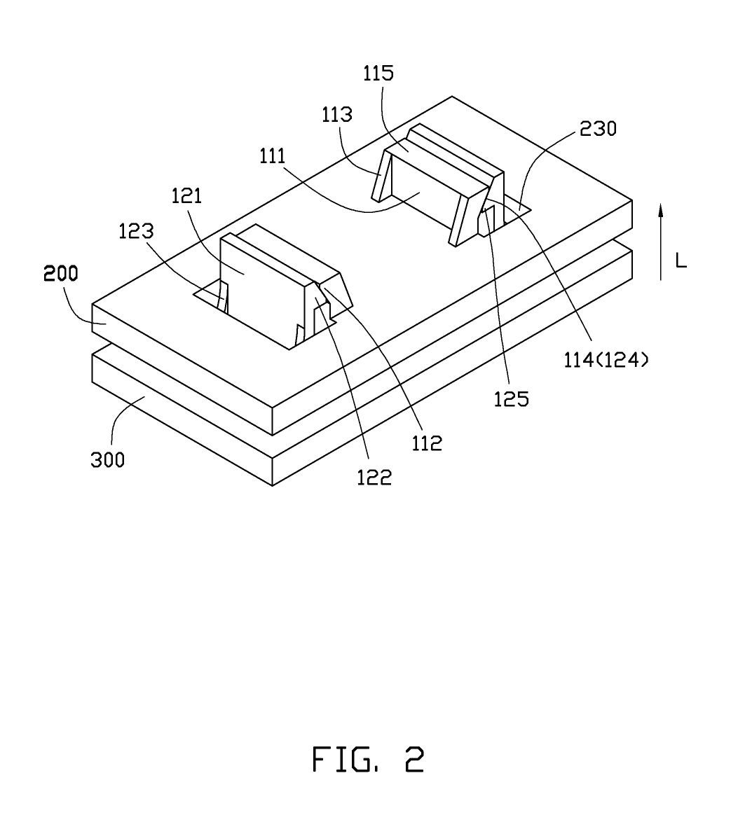

When the second object 200 is to be connected to the first object 300, the second object 300 is moved to the first object 200 in a direction L as shown in FIG. 2. As the second locking members 120 pass through the through holes 230 respectively, the third surface 310 of the second object 300 get closer to the second surface 220 of the first object 200, and the second engaging portions 122 get closer to the first engaging portion 112 respectively. The second guiding surface 124 slides across the corresponding first guiding surface 114. As the second guiding surface 124 slides completely across the corresponding first guiding surface 114, the second abutting surface 125 abuts the corresponding first abutting surface 115. At this time, the second object 300 is locked to the first object 200 and cannot move away from the first object 200. Also, the support ribs 123 of each second locking member 120 abut sides of the corresponding through hole 230, avoiding loose engagement between the second locking member 120 and the corresponding through hole 230.

It should be understood that since the two first engaging portions 112 face away from each other and the two second engaging portions 122 face each other, therefore, after the first object 200 is locked to the second object 300, each second engaging portion 122 abuts the corresponding first engaging portion 112 in a direction from one through hole 230 to another one, avoiding unwanted movement of the second object 300 relative to the first object 200 in this direction.

It should be understood that since the reinforced ribs 113 abut the main body 111 of each first locking member 110, then even if an outer force from the corresponding second locking member 120 is applied to the main body 111, the main body 111 may not be deformed easily. The same applies to the second locking members 120 because of the support ribs 123. Additionally, since the flanges 1230 of each support rib 123 are arced, the bearing capacity of the support ribs 123 is enhanced. In the illustrated embodiment, the first locking members 110 and the second locking members 120 are made of elastic material, which can prevent damage to and deformation of the locking structure 100.

It should be understood that the number of the first locking members 110 and the second locking members 120 are not limited to this embodiment. In some situations where the first locking members 110 and the second locking members 120 are made of elastic material, the locking structure 100 can include one first locking member 110 and one second locking member 120.

With the locking structure 100, the second object 300 can be locked to the first object 200 easily and stably.

Even though information and the advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A locking structure for locking a first object with a second object, comprising:
two first locking members disposed on the first object, each first locking member comprising a main body protruding from the first object and a first engaging portion protruding from the main body, the first engaging portions of the two first locking members facing away from each other; and
two second locking members disposed on the second object for engaging with the first locking members respectively, each second locking member comprising a main part protruding from the second object and a second engaging portion protruding from the main part, the second engaging portions of the two second locking members facing each other;
wherein the second engaging portions engage with and abut the first engaging portions respectively to lock the second object to the first object as the two second locking members pass through the first object.

2. The locking structure as claimed in claim 1, wherein two through holes are defined in the first object with the two first locking members disposed therebetween, and the second locking members pass through the first object through the through holes.

3. The locking structure as claimed in claim 2, wherein each first engaging portion and each second engaging portion are wedge shaped.

4. The locking structure as claimed in claim 3, wherein each first engaging portion defines a first guiding surface, each second engaging portion defines a second guiding surface being slidable relative to the corresponding first guiding surface.

5. The locking structure as claimed in claim 4, wherein both the first guiding surface and the second guiding surface are inclined surfaces.

6. The locking structure as claimed in claim 4, wherein each first engaging portion further defines a first abutting surface connected to the first guiding surface, each second engaging portion further defines a second abutting surface connected to the second guiding surface and abutting the first abutting surface.

7. The locking structure as claimed in claim 2, wherein each first locking member further comprises at least one reinforced rib disposed between the main body and the first object for avoiding deformation of the main body in a first direction from the corresponding through hole to the other through hole.

8. The locking structure as claimed in claim 7, wherein each second locking member further comprises at least one support rib disposed between the main part and the second object for avoiding deformation of the main part in a second direction opposite to the first direction.

9. The locking structure as claimed in claim 1, wherein the first locking members and the second locking members are made of elastic material.

10. A locking structure for locking a first object to the second object, comprising:
at least one first locking member protruding from the first object;
at least one second locking member protruding from the second object;
wherein the at least one second locking member engages with the at least one first locking member to abut the at least one first locking member to lock the second object to the first object as the at least one second locking member passes through the first object.

11. The locking structure as claimed in claim 10, wherein at least one through hole is defined in the at least one first object, the at least one second locking member passes through the at least one first object through the at least one through hole.

12. The locking structure as claimed in claim 10, wherein each first locking member comprises a main body protruding from the first object and is adjacent to the corresponding through hole, and a first engaging portion disposed on one side of the main body and partly protruding above the through hole.

13. The locking structure as claimed in claim 12, wherein each second locking member comprises a main part protruding from the second object and a second engaging portion disposed on one side of the main part, the second engaging portion slides relative to the first engaging portion to abut the first engaging portion to lock the second object to the first object.

14. The locking structure as claimed in claim 13, wherein the first engaging portion defines a first guiding surface, and the second engaging portion defines a second guiding surface parallel to the first guiding surface being slidable relative to the first guiding surface.

15. The locking structure as claimed in claim 14, wherein the first guiding surface and the second guiding surface are inclined surfaces.

16. The locking structure as claimed in claim 14, wherein each first locking member comprises at least one reinforced rib disposed between the main body and the first object for preventing the main body from deforming away from the corresponding through hole.

17. The locking structure as claimed in claim 16, wherein each second locking member comprises at least one support rib disposed between the main part and the second object for preventing the main part from deforming along a second direction opposite to the first direction.

18. The locking structure as claimed in claim 17, wherein the second support rib abuts the through hole when the second engaging portion abuts the first engaging portion.

19. The locking structure as claimed in claim 10, wherein the at least one first locking member and the at least one second locking member are made of elastic material.
